(19) United States
(12) Patent Application Publication
(10) Pub. No.: US 2010/0047413 A1
(43) Pub. Date: Feb. 25, 2010

(54) METHOD OF USING AMPHIPHILIC MULTIBLOCK COPOLYMERS IN FOOD

(76) Inventors: LeAnne M. Cabalka Tourtellotte, Oak Park, IL (US); Waiken K. Wong, Oak Park, IL (US)

Correspondence Address: Reed Smith, LLP, 10 SOUTH WACKER DRIVE, CHICAGO, IL, 60606-7507, US

(21) Appl. No.: 12/440,796

(22) PCT Filed: Sep. 14, 2007
(86) PCT No.: PCT/US07/78535

§ 371 Date: Oct. 15, 2009

Related U.S. Application Data
(60) Provisional application No. 60/825,877, filed on Sep. 15, 2006.

(51) Int. Cl. A23L 3/37; A23L 3/34

(52) U.S. Cl. 426/327; 426/321

(57) ABSTRACT

The present patent discloses a method of processing food in a manner so that the processed food can be stored in freezer or other similar environment for an elongated period of time with reduced amount of freezer burns or undesirable ice crystal formation, in a manner so as to maintain food freshness over a longer period of time, or in a manner so as to prevent protein aggregation over an elongated period of time. An embodiment of this method uses amphiphilic multiblock copolymers, such as poloxamer, meroxapols, poloxamines or polyols in such food processing and handling.

### FIELD

This patent relates to a method for processing a food and specifically a process for food preparation, enhancement and storage.

### SUMMARY

The present patent discloses a method of processing food in a manner so that the processed food can be stored in freezer or other similar environment for an elongated period of time with reduced amount of freezer burns or undesirable ice crystal formation, in a manner so as to maintain food freshness over a longer period of time, or in a manner so as to prevent protein aggregation over an elongated period of time. An embodiment of this method uses amphiphilic multiblock copolymers, such as poloxamer, meroxapols, poloxamines or polyols in such food processing and handling.

### BRIEF DESCRIPTION OF THE DRAWINGS

While the appended claims set forth the features of the present patent with particularity, the patent, together with its objects and advantages, may be best understood from the following detailed description taken in conjunction with the accompanying drawings, of which:

FIG. 1 illustrates a diagram of amphiphilic multiblock copolymer substances;

FIG. 2 illustrates a diagram of an amphiphilic multiblock copolymer substance acting as an antifreeze molecule situated on ice domain of a food;

FIG. 3 illustrates various photographs of crystal growth in food without an amphiphilic multiblock copolymer substance and in food with an amphiphilic multiblock copolymer substance according to an application.

FIG. 4 illustrates various photographs of crystal growth in food without an amphiphilic multiblock copolymer substance and in food with an amphiphilic multiblock copolymer substance according to another application.

FIG. 5 illustrates a diagram of a series of events wherein an amphiphilic multiblock copolymer substance is introduced to hydrophobic protein domains and their surrounding aqueous environment, thereby affecting aggregation; and

FIG. 6 illustrates various photographs of decay or spoilage in food product without an amphiphilic multiblock copolymer substance and in food with an amphiphilic multiblock copolymer substance according to an application.

### DETAILED DESCRIPTION

### Amphiphilic Multiblock Copolymer.

A multiblock copolymer is a polymer synthesized from at least two different monomer types and where those monomers are strung together within the overall polymer structure such that there are significantly long stretches of a single monomer type. A diblock copolymer would have an AB form where A is the polymerization of one monomer type and B is the polymerization of another. A triblock copolymer could take the form of ABC, with three distinct monomer types, or ABA, where there are only two different monomer types but three distinct regions in the overall polymer.

An amphiphilic polymer is one that has both hydrophilic and hydrophobic domains and therefore is thermodynamically able to reside at the interface of such domains. Amphiphilic molecules have reasonable solubility in both aqueous and organic solvents and are capable of forming micellar structures in solution.

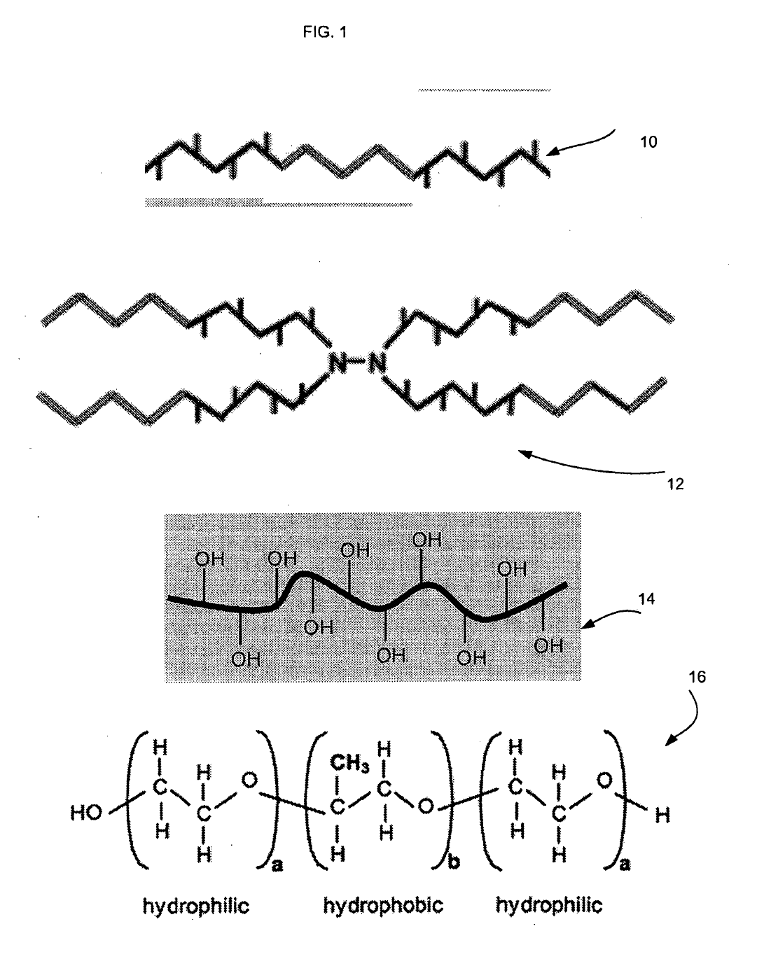

FIG. 1 illustrates the chemical formulas of several Amphiphilic Multiblock Copolymers (AMCs). Specifically FIG. 1 illustrates chemical formulas of meroxapol 10, poloxamine 12, a polyol 14 and poloxamer 16. A poloxamer is a triblock copolymer of the form ABA where the A blocks are polyethylene oxide (PEO) and the B block is polypropylene oxide (PPO). One formulation of poloxamer designated Poloxamer 188 (P188) by its manufacturer, BASF, has an average molecular weight of 8400 g/mol with approximately 80% by weight PEO. Meroxapols reverse the configuration of poloxamers; they are triblock polymers of PPO-PEO-PPO. Poloxamines can be described as four-armed star polymers; four PEO-PPO arms are linked together by two nitrogens at their PPO ends. Polyols are polymers that have hydroxyl functional groups along their backbones.

### Process of Crystal Growth in Food.

There is a class of naturally-occurring proteins, mostly found in animals and plants that live in sub-zero conditions, which interfere with crystallization of ice. Their nomenclature is still a matter of discussion, but the broadest descriptor of these molecules would be ice structuring proteins (ISPs) or ice active proteins (IAPs). Under these umbrella terms, these compounds can be further delineated into antifreeze proteins (AFPs), ice nucleating proteins (INPs), and recrystallization inhibiting proteins (RIPs). While not all these terms are widely used, they do encompass the range of observed effects these molecules have on ice.

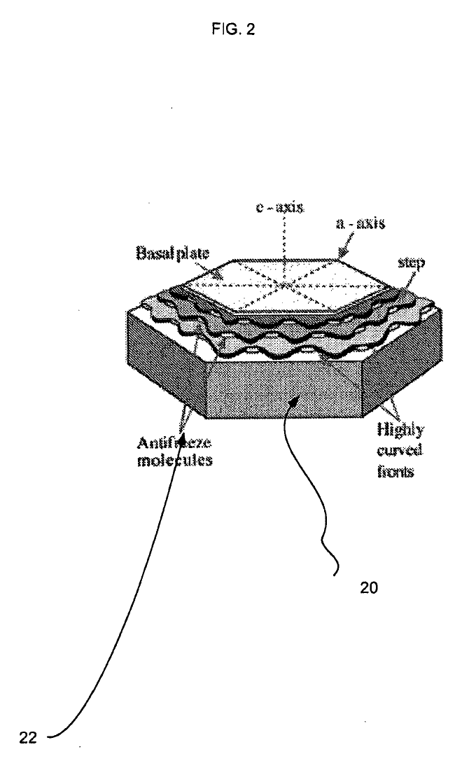

The mechanism of IAPs' interaction with ice crystals may be due to hydrogen bonding, hydrophilic interactions, or hydrophobic interactions, or a combination thereof, driving the IAPs to adhere to the surface of ice crystals or nucleation sites. Once there, propagation of the ice crystal is confined to regions between adhered IAP molecules, regions that are curved due to the sterics of the adhered molecules. Continued growth in these curved regions is thermodynamically unfavored because of the energy required to build structures with a high surface area compared to their volumes. With this thermodynamic barrier, ice growth is inhibited. FIG. 2 illustrates a diagram of an antifreeze molecule situated on an ice crystal. Specifically FIG. 2 illustrates the ice crystal represented by the hexagonal structure, the antifreeze molecules represented by the yellow bars, and the growing ice crystal front represented by the heavy lines. The growth front is forced into unfavorable, curved configurations.

### Using AMCs to Prevent Crystal Growth in Food.

AMCs may behave in a similar fashion in that their amphiphilicity would give them an affinity for ice crystal surfaces. This would be particularly true in food, which often are emulsions or mixtures of water and oil/fat components, and our compounds would be drawn to the interface between those components. (As referred to herein, “food” incorporates raw food material including but not limited to meat, vegetables, dairy, grains, etc., and any edible products/components derived therefrom, such as processed food including but not limited to ready to eat food, canned or packaged food, etc.). Once AMC molecules have situated themselves on ice domains, they would inhibit further ice growth through the same mechanisms that govern IAP behavior.

FIG. 2 illustrates a diagram of an MAC substance situated on ice domain of a food product. Specifically FIG. 2 illustrates an item of food 20 with a plurality of AMC substance 22 (as antifreeze molecules) attached to the ice domain (as represented by the highly curved fronts) of the food item 20.

For example, with regards to food such as ice cream or sherbet, ice crystal formation and freezer burn may be due to crystallization of native water content in the food product that may get pushed to the surface. Alternatively, such crystal formation and freezer burn may be due to crystallization of water content that is absorbed by such food from the surroundings, such water content that may be referred to as migrating water content. Migrating water content may create ice crystals and freezer burn that is unwanted in frozen confections and other foods.

Storage temperature is critical to the quality of frozen confections and at the same time sustaining the low temperatures needed to maintain quality is a costly process energetically and economically. Being able to prevent or reduce freezer burn, ice crystal growth, or other temperature-dependent phenomena would mean allowing the stringency of the storage conditions to be lessened.

The mechanism by which AMC additive to food resists crystal formation and freezer burn in the food is similar to that described above with respect to IAP's. Specifically, the mechanism of AMCs' interaction with ice crystals may be due to hydrogen bonding, hydrophilic interactions, or hydrophobic interactions, or a combination thereof, driving the AMCs to adhere to the surface of ice crystals or nucleation sites. Once there, propagation of the ice crystal is confined to regions between adhered AMC molecules, regions that are curved due to the steric effects of the adhered molecules. Continued growth in these curved regions is thermodynamically unfavored because of the energy required to build structures with a high surface area compared to their volumes. With this thermodynamic barrier, ice growth is inhibited in food having AMC additives.

To produce food that is resistant to freezer burns or ice crystallization, the AMCs may be added to the food in a variety of manners. For example, AMCs may be added to already made frozen foods or it may be added to the food during its processing. Thus, products containing AMCs may be sold to grocery stores, warehouses, etc., storing such food. Alternatively, products containing AMCs may even be sold to consumers with instructions for its use so that the consumers may add such products to not only food purchased from grocery stores, but also to food generated at home, such as meals, sauces, etc., that the consumer may want to freeze for an elongated period of time.

Alternatively, with ice creams and sherberts, the AMCs may be incorporated as an ingredient during the manufacturing process. Moving back even further in the supply chain, the AMCs could also be delivered to live animals as animal food or as a veterinary pharmaceutical before their slaughtering. Alternatively, AMC's may be included in fertilizers or other farming products in a manner so as to be absorbed by the vegetable, grains, etc.

There have also been other suggestions of using IAPs derived from natural sources as frozen food additives. For example, AFPs from fish have been incorporated into prototype ice creams. However, the methods and processes described herein are unique in that a synthetic molecule, such as an AMC molecule, rather than a natural one is added to the food to allow the food to be stored for a longer period of time while preventing undesired crystal growth. As one of ordinary skill in the art would appreciate, such synthetic molecules may be mass-produced in a controlled manner at low cost compared to the natural molecules such as AFPs, etc.

Following are examples of several applications of the above-described method for inhibiting ice crystal growth in food and food.

### Application 1

In this application, 5 g of grocery store-purchased chocolate ice cream was placed in a 20 mL glass scintillation vial with plastic screw cap. P188 at 5.0 wt % was dissolved into one vial of melted ice cream. Another vial of ice cream was untreated except for undergoing the same melt/refreeze cycle as the other vial. Dissolution of P188 was aided by vortexing the vials and as determined by visual inspection. Vials were placed on their sides in a freezer to maximize the observable surface area. Samples were checked several times a week for observable visual changes in texture, to see whether there was any presence of ice crystals on the surface or freezer burn and to qualitatively measure the amount of such ice crystals or freezer burns. The surface textures of both samples were recorded at the beginning of the application. Both samples had the same, smooth surface at the beginning.

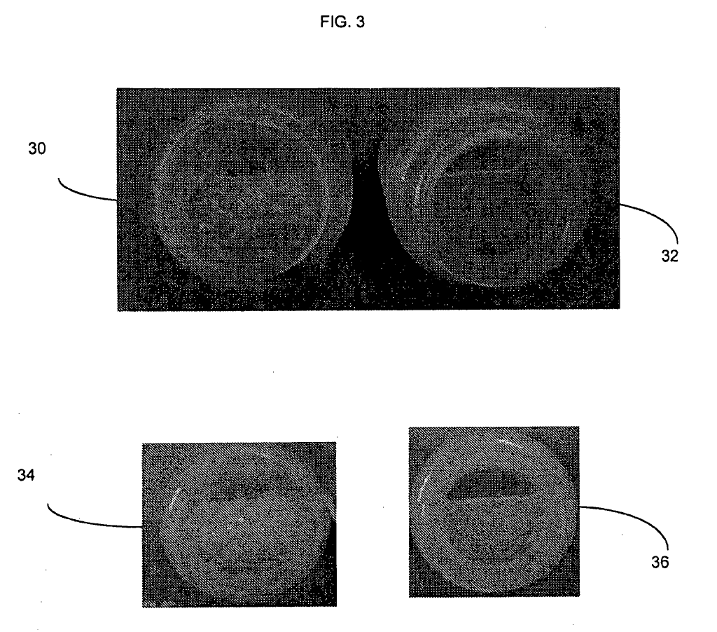

The surface texture ice cream of both containers was monitored over a period of time. FIG. 3 shows images of the surface texture of the containers at various subsequent points in time. Specifically, images 30 and 32 illustrate the images of the containers after 4 days, with the ice cream with P188 being shown in image 32, whereas images 34 and 36 illustrate the images of the containers after 25 days, with ice cream with P188 being shown in image 36.

As it can be seen from the images 30-36, the ice cream containing P188 has fewer ice crystals, has a more uniform texture, and its surface more closely resembles its original condition compared to the untreated ice cream.

### Application 2

In this application, 5 g of grocery store-purchased raspberry sherbet was placed in a 20 mL glass scintillation vial with plastic screw cap. P188 at 5.0 wt % was dissolved into one vial of melted sherbet. Another vial of sherbet was untreated except for undergoing the same melt/refreeze cycle as the other vial. Dissolution of P188 was aided by vortexing the vials and was determined by visual inspection. Vials were placed on their sides in a freezer to maximize the observable surface area. Samples were checked at the beginning of the application and at several times a week for observable visual change in texture to see whether there was any presence of ice crystals on the surface or freezer burn to qualitatively measure the amount of such ice crystals or freezer burns. Both samples had the same, smooth surface at the beginning.

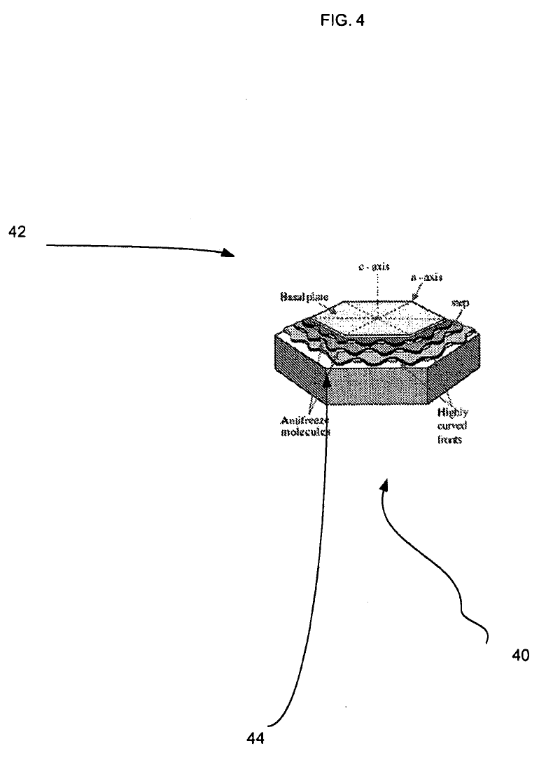

The surface texture sherbet in both containers was monitored over a period of time. FIG. 4 shows images of the surface texture of the vials at various subsequent points in time. Specifically, images 40 and 42 illustrate the images of the vials after 5 days, with the sherbet with P188 being shown in image 42, whereas images 44 and 46 illustrate the images of the vials after 34 days, with sherbet with P188 being shown in image 46.

As can be seen from the images 40-46, the sherbet containing P188 has fewer ice crystals, has a more uniform texture, and more closely resembles its original condition than the untreated sherbet.

While in the applications described above P188 at 5.0 wt percentage was added to the food, as one of ordinary skill in the art can appreciate, alternate amounts of P188 may also be added to achieve alternate levels of the illustrated effects. For example, in alternate implementations of the applications described above, P188 in the amount of a range of weight percentages was added to food, such range being from 0.05% to 10%.

In an alternate application, two 200 mL containers of milk were stored in a very cold refrigerator. One container had 5 wt % P188 added to it while the other was untreated. The milk in each of the two containers were from the same original volume. After overnight storage, the milk with no P188 was frozen solid while the milk with P188 was still liquid. This clearly shows that the method described in here may be used to prevent ice crystal growth using P188 or other AMCs.

Yet alternately, in alternate application combinations of the various AMCs may be added to the food instead of only the P188. For example, in an alternate implementation of the applications described above combination of P188 and alternate AMC, such as a poloxamine may be added to sherbet or other food.

### Maintaining Food Processability.

Fluctuations in temperature, pH, pressure, concentration, and other conditions during the processing or manufacturing environment of food can lead proteins in such food to change conformation. As conformational changes in food take place, hydrophobic domains in such food, which were once protected, are then exposed to aqueous surroundings. Subsequently, hydrophobic forces may drive these regions together, creating aggregations which may have observable effects up to the macro level.

Such observable macro level effects may be detrimental to appeal of such food. For example, protein shakes used by athletes that contain protein additive are susceptible to such aggregation of protein molecules. As a result, the protein content in such shakes appear as lumps at bottom of containers and make the protein shake less appealing to a consumer, who may think the shake has spoiled. Therefore, it is desirable to prevent such aggregation in food to the extent it is possible without affecting the quality of food.

A method described in this patent uses certain AMC, such as P188 to reduce or eliminate the amount of such aggregation in food. The molecules of such AMC compounds have an affinity for the interface between the hydrophobic protein domains and the surrounding aqueous environment. Once the molecules are close to the interface between the hydrophobic protein domains and the surrounding aqueous environment, they alter the hydration shells around the proteins, effectively changing the local water structure.

In another example, a food products manufacturer processing protein mixtures or slurries may desire to keep the stream as uniform as possible with no aggregates that would clog the system. Maintaining such uniformity and optimal viscosity also ensures desired levels of productivity. A method described herein allows the manufacturer to use AMC substances to achieve such results.

In another example, a food manufacturer may desire to raise the protein content of their product for nutritional or other reasons while maintaining a certain texture or viscosity. As the increased addition of large molecules like proteins will naturally increase viscosity, a method is required to increase the protein fraction without significant decrease in quality or processability. This would be applicable in foods where proteins are already present as an ingredient or component, or in foods where protein is being used to replace another ingredient or component. The replacement of the fat content with protein content in ice cream-like foods is an example of the latter. A method described herein allows the manufacturer to use AMC substances to achieve such results.

As shifts in the hydration of the biomolecules occur, the protein then has the freedom to reorient once more. Because the blueprint for a protein's native, solubilized conformation is contained within its primary structure, once the protein has the ability to change conformational states, it can revert back to its soluble configuration. Such a solubilized protein is no longer controlled by hydrophobic forces, wherein the driving force for aggregation is no longer a significant factor in the dynamics of the molecule.

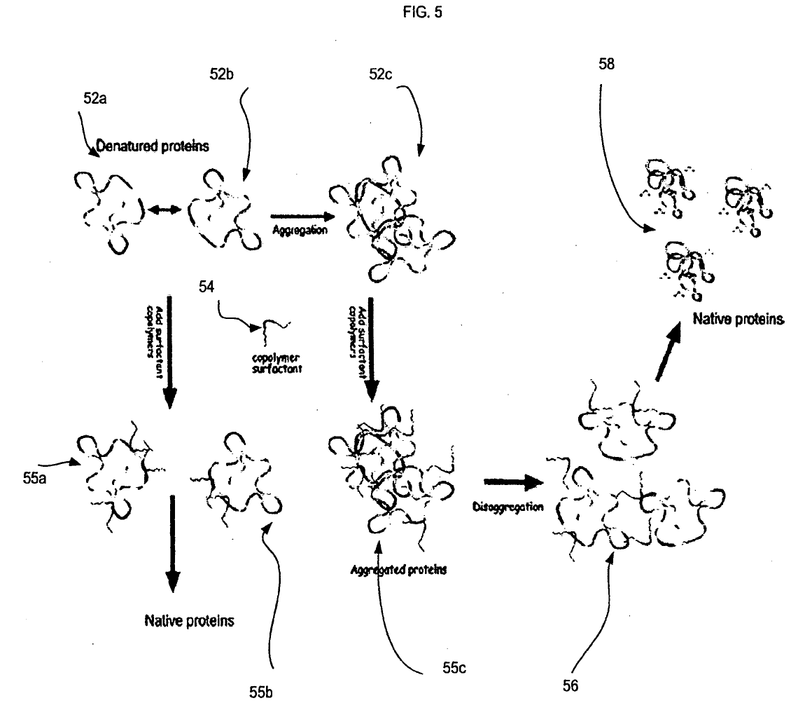

FIG. 5 illustrates a diagram of an AMC molecule situated between a hydrophobic protein domain and its surrounding aqueous environment. Specifically FIG. 5 illustrates two protein molecules 52a and 52b, wherein they and proteins in similar states go through an aggregation process to be converted into a protein aggregate 52c. Alternatively, they can remain as single, denatured proteins in the environment. When an AMC substance 54 is added to the food containing the proteins 52a -c, as shown in 55a and 55b, the AMC substance attaches to the proteins. 56 shows that the attachment of the AMC substance molecules to the proteins causes the proteins to become disaggregated, then returned to their native, solubilized states as shown in 58. The small molecules surrounding the proteins in 58 are water molecules, now able to closely associate with the protein again.

The method described herein uses this manifestation of protein behavior, by using P188 or other AMC compound as a means of both reversing and preventing protein aggregation. Specifically, according to the method described herein, AMC or similar compound is added to a food or food product during its processing.

Further more, intracellularly, classes of molecules called protein chaperones shepherd proteins as they are synthesized and afterwards as they reside in cells. Particularly at early stages of a protein's life cycle, these chaperones play a vital role in protecting the growing polypeptide, ensuring that the final molecule is folded properly in regards to its bio-functionality. In cases of trauma to the cell, protein chaperones may also have reparative functions for damaged proteins. Thus, the AMCs or similar compounds can also be used to affect a protein's folding or bio-functionality. An implementation of the method described herein provides for adding AMC such as P188 to food product containing a protein in a manner that will control aggregation. This implementation may secondarily affect the subsequent folding or bio-functionality of the protein.

### Enhancing Food Safety.

Another method described herein provides for using AMC such as P188 to inhibit spoilage of food, particularly protein-containing foods such as milk and meat. According to this method AMC substance is added to such food during processing to allow the AMC to interact and interfere with enzymatic processes that lead to spoilage or decay of such food. In the case of milk, spoilage is due primarily to the breakdown of proteins (casein and whey, preference for casein) and lipids, both of which occur through enzyme activity. Some enzymes are present naturally in milk while others are often introduced through contamination during production, processing, and storage. Many of these enzymes have been found to be heat-resistant, which makes their elimination via high temperature pasteurization difficult. P188 interference with enzymatic processes is thought to be initiated as P188 is drawn to functional moieties of either enzyme or substrate, becoming a competitive (though non-specific) inhibitor at the enzyme's active site.

Alternatively, P188 may serve as a protector against enzymatic activity for proteins, perhaps through actions similar to what it does in controlling aggregation in the uses described above. In the process of creating and maintaining a hydration shell around the molecule, P188 may be a steric hindrance for enzymes seeking to bind with the protein. Other spoilage events, including but not limited to lipidolysis, fermentation, and oxidation, may also be affected in the same manner by AMCs.

Following are examples of several applications of the above-described method for inhibiting protein aggregation in food.

### Application 1

In this application, samples are selected to be approximately 15 gram chunks of ground beef. Note that in an alternate application any other type or amount of food may be selected as sample. The applicational matrix is as follows: (a) No AMC added to the sample; (b) 5 wt % P188 mixed straight into the sample; and (c) 5 wt % P188 mixed into the sample via a solution. For (b), solid P188 was added to the sample and was kneaded in until it was unseen. The P188 was assumed to have been evenly distributed at this point. For (c), 0.75 g of P188 is dissolved into 5 mL deionized (DI) water and then the resulting solution was mixed in with the meat. All samples are stored wrapped in foil and their shelf life was determined by smell tests and visual inspection at the beginning of the application and at a regular interval of time.

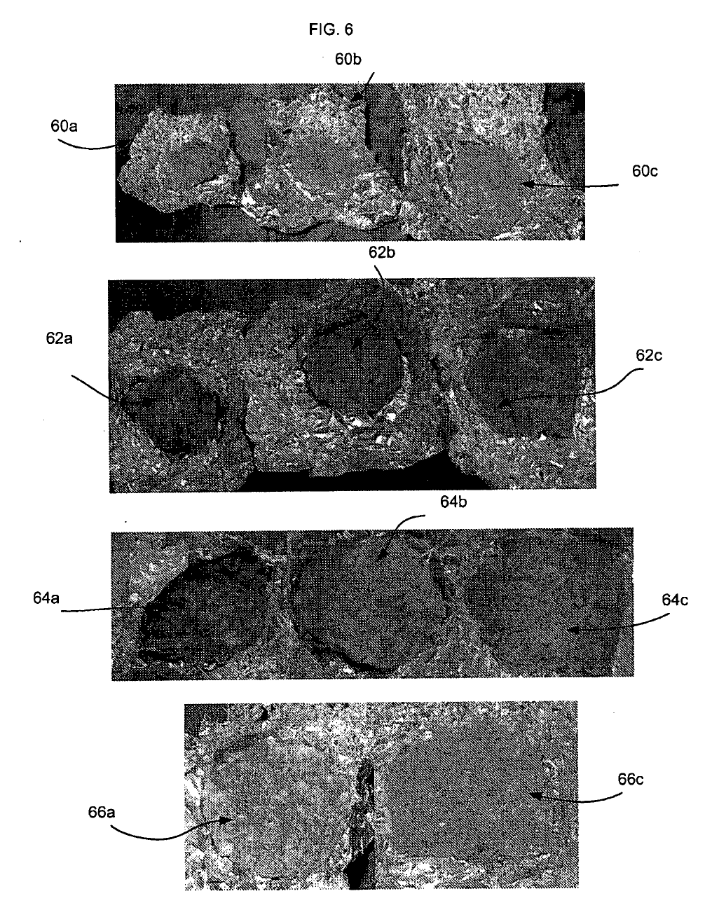

FIG. 6 shows the images of the sample at various intervals. Specifically, 60a, 60b and 60c show images of the samples according to the applicational matrix a-c, respectively (i.e., 60a being image of sample with no AMC, 60b being image of sample with solid P188 and 60c being image of sample with dissolved P188) at the end of a six-day period. It was observed that samples (a) and (b) are beginning to show the browning expected of meat that has been exposed to air, whereas sample (c) retained the red color of fresh ground meat over the observation period. Additionally, the texture of (c) is smoother compared to texture of samples (a) and (b) as a result of its higher liquid content.

Images 62a, 62b and 62c show images of the samples at the end of a nine-day period. Further discoloration of all samples is seen, however, the discoloration of the sample without P188 is the worst compared to discoloration of the other two samples. Similarly, images 64a, 64b and 64c show images of the samples at the end of a thirteen-day period. It was observed that at this time, sample (a), one without an AMC, has gone bad, confirmed both visually and by smell. Samples (b) and (c) no longer smell fresh, but are not outright rancid. Sample (c) still has some redness. Finally, 66(b) and 66(c) show images of samples (b) and (c) at the end of a thirty-three-day period. It is observed that sample (b) on the left has gone bad, confirmed both visually and by smell, whereas sample (c) still does not have an outright rancid smell, although it is worse than it was at the previous time-point. Moreover, sample (c) still has some redness. Sample (a) was discarded after it had gone bad and thus is not included in 66. Thus, it can be seen that using the method disclosed herein, the freshness of meat may be preserved for an elongated period of time.

### Application 2

In this application, milk from single serving plastic containers is pooled and redistributed into the same containers after the containers are rinsed, each container having approximately 200 mL milk. P188 is dissolved in concentrations of 0.0, 0.1, 1.0, and 5.0 mM into milk. Dissolution is aided by vortexing the vials and is determined by visual inspection. Containers are stored in a refrigerator for at least 24 hours but are allowed to come to room temperature before the application is performed. Included in this large set of samples was a control sample with no P188 and receiving no other treatment.

The milk is transferred to a glass beaker and heated to either 85 or 95° C., where it is held for one minute before removal from heat. The beaker is covered with foil (with the thermometer poking through in one spot) to prevent excessive evaporation. Samples are returned to the refrigerator for storage after cooling to room temperature. Taste and smell are evaluated at several time points after the heating. These tests are conducted after the milk is allowed to warm to room temperature.

It was found that for both sets of milk that were heated, the sample without any P188 was the first to spoil (judged by smell), at 13 days. Thus, it can be seen that using the method disclosed herein, the freshness of milk may be preserved for an elongated period of time.

In another control application, two containers of milk, one containing 5 mM P188 and one untreated, are stored in a refrigerator until they spoil. No heat treatment takes place. As in the case of the heated samples, the sample without P188 spoiled first.

The Examples given illustrate the content of the invention without limiting its scope only to the Examples described.

In view of the many possible embodiments to which the principles of this patent may be applied, it should be recognized that the embodiments described herein with respect to the drawing figures are meant to be illustrative only and should not be taken as limiting the scope of patent. For example, for performance reasons one or more components of the method of the present patent may be implemented in any of various alternate manners well known to those of ordinary skill in the art. Therefore, the patent as described herein contemplates all such embodiments as may come within the scope of the following claims and equivalents thereof.

What is claimed is:

1. A method of processing food in a manner so that processed food can be stored in freezer or other similar environment for an elongated period of time with reduced amount of freezer burns or unwanted ice crystal formation, the method comprising:
adding an amphiphilic multiblock copolymer substance to the food.

2. The method of claim 1, wherein the amphiphilic multiblock copolymer substance is one from the group of poloxamer, meroxapols, poloxamines and polyols.

3. A method of processing food in a manner so as to maintain food freshness over a longer period of time, the method comprising:
adding an amphiphilic multiblock copolymer substance to the food.

4. The method of claim 3, wherein the amphiphilic multiblock copolymer substance is one from the group of poloxamer, meroxapols, poloxamines and polyols.

5. A method of processing food in a manner so as to prevent protein aggregation in the processed food over an elongated period of time, the method comprising:
adding an amphiphilic multiblock copolymer substance to the food.

6. The method of claim 5, wherein the amphiphilic multiblock copolymer substance is one from the group of poloxamer, meroxapols, poloxamines and polyols.
